(19) United States
(12) Patent Application Publication
(10) Pub. No.: US 2011/0041400 A1
(43) Pub. Date: Feb. 24, 2011

(54) METHOD AND DEVICE FOR TREATING PLANT SEEDS

(75) Inventors: Jose Trias Vila, Palm City, FL (US); Barthelomeus Johannes Theodorus Smit, PH Hoogkarspel (NL); Wilhelmus Antonius Maria Van Lith, EM Nijmegen (NL)

Correspondence Address: BROOKS KUSHMAN P.C., 1000 TOWN CENTER, TWENTY-SECOND FLOOR, SOUTHFIELD, MI, 48075, US

(73) Assignee: SYNTHESIS B.V., EM Nijmegen (NL)

(21) Appl. No.: 12/666,149

(22) PCT Filed: Jun. 20, 2008
(86) PCT No.: PCT/NL08/50403

§ 371 Date: Mar. 16, 2010

(30) Foreign Application Priority Data
Jun. 22, 2007 (NL) 2000719

(51) Int. Cl. A01C 1/02; A01C 1/00

(52) U.S. Cl. 47/58.1 SE; 47/1.1 R

(57) ABSTRACT

In intensive agriculture it is important to provide high-quality seeds with a good, rapid and uniform germination. The invention relates to a method for treating plant seeds. The invention also relates to a device for treating plant seeds by applying such a method.

The invention relates to a method for removing germination inhibitors from plant seeds. The invention also relates to a device for removing germination inhibitors from plants seeds by applying such a method.

In intensive agriculture it is important to provide high-quality seeds with a good, rapid and uniform germination. In order to improve the seed quality in these respects, seed which in dry state displays hardly any metabolic activity, and is therefore resting, is activated (also referred to as priming) by treating the seed, for instance with water. This interrupts the resting stage and germination is stimulated. Due to the treatment the seed takes up water (imbibition), whereby germination processes which are not discernible from outside begin in the seed. The treatment with water does however involve a great risk, that the seeds will actually begin to germinate (i.e. the tip of the root penetrates through the pericarp). It must however be the objective that the water treatment is interrupted just before the moment of germination so that germination does not occur. After the treatment the seeds can be sown or dried (dehydrated). It has been found that the pretreated, dehydrated seeds display a high measure of germination synchronicity when they are sown, and moreover keep well in this dry state. Salts, such as for instance NaOCl, are usually added to the water to disinfect the seeds by killing micro-organisms on and in the seeds, this in order to preserve the health of the seeds. A temperature treatment (pasteurization) optionally also takes place here which is also intended to kill micro-organisms present on or in the seeds. This pasteurization usually results however in a poorer germination of the seeds, whereby this step is generally less suitable for disinfecting the seeds. The known treatment method has a number of drawbacks. A significant drawback of the known method is that the washing process is effective to only a limited extent because the washing process is only suitable for removing (some of the) micro-organisms. The natural physical and physiological barriers, also referred to as germination inhibitors, present around and between the seeds which impede water absorption by the seeds are here not removed, or hardly so, by applying the known washing process. The continuing presence of these barriers, even after washing of the seeds, thus impedes water absorption by the seeds, and therefore germination in the seeds. Furthermore, due to the presence of these natural barriers not all pathogens (micro-organisms) and counter-productive active substances, such as for instance determined hormones, present in the seeds will generally be flushed away during the known washing process, and this detracts from the germinative capacity of the seeds, and therefore from the seed quality.

The invention has for its object to provide an improved method for treating plant seeds, using which seeds of an improved seed quality can be obtained.

The invention provides for this purpose a method of the type stated in the preamble, comprising the steps of: A) moistening plant seeds for a period of time with aqueous liquid comprising a salt, which liquid has a pH lying between 7.5 and 14, and B) drying for a period of time the seeds moistened during step A). The flushing liquid used is alkaline and has particularly a pH lying between 7.5 and 14, preferably between 8 and 13, more preferably between 9 and 13 to enable dissolving, or at least removal, of the physical and physiological barriers (germination inhibitors) between, on and in the seeds. One of the barriers is formed here by phenol, a component which can be removed using a flushing liquid with a pH of about 9. Other components which can also be deemed as barrier to absorption of water by the seeds are lignin and cellulose, which components can be removed using a flushing liquid with a pH preferably lying above 9. Because the physical and physiological barriers can be substantially removed by applying the alkaline flushing liquid, micro-organisms and counter-productive active substances, such as for instance hormones, present in the seeds can also be removed relatively effectively from the seeds. In addition to a sufficient basicity of the aqueous flushing liquid, the flushing liquid applied during step A) is provided with an in any case at least partially dissolved salt in order to keep the osmotic potential of the flushing liquid sufficiently low. By keeping the osmotic potential of the flushing liquid sufficiently low it will be possible to maintain the level of the salt content in the seeds in relatively simple manner. The osmotic potential of the flushing liquid must however preferably also be sufficiently high here to be able to prevent dehydration of the seeds. By applying the salt-containing alkaline flushing liquid the plant seeds can be washed in relatively effective and efficient manner, which enhances the seed quality whereby a better germination is made possible. Applying the salt-containing alkaline flushing liquid will result in an at least partial break open of the seed coat of the seed washed to remove the germination inhibitors at least partially from the plant seeds. However, this break open also considerably facilitates access to pathogens initially contained by the seeds, as a result of which these pathogens can be treated by e.g. a disinfecting substance. It has also been found that the at least partial destruction of the seed coats considerably facilitates an eventual subsequent vernalisation process, wherein the washed seeds are conserved, typically for a couple of weeks at relatively low temperatures (typically about 2 to 4 degrees). A vernalisation process can be favourable for seed production purposes wherein a seed embryo is forcedly induced to flower at a premature stage. The liquid used to wash the plant seeds consists particularly of about 90% or more of water. Although the method is in principle suitable for pretreatment of the seeds with any random liquid, the pretreatment generally takes place with water. This washing liquid can also comprise additional substances, such as minerals, hormones, pesticides, stimulants and/or micro-nutrients. All types of phenols and direct derivatives thereof can be removed from the seeds by means of the method according to the invention. The invention is therefore not limited merely to the removal of phenyl alcohol (benzenol) from the seeds. The plant seeds can be of various nature, and may be formed either by grass seeds or non-grass plant seeds, such as vegetable seeds, flower seeds and industrial crop seeds.

The washing process according to step A) is preferably performed with a flushing liquid at a temperature lying between 2 and 55° C., more preferably between 2° C. and room temperature (between 15 and 30° C. depending on the prevailing climate), and in a particular preferred embodiment between 3 and 8° C. At these relatively low temperatures a satisfactory washing and moistening of the seeds can be realized on the one hand and (premature and excessive) germination of the seeds can be prevented on the other. The optimum temperature depends on the nature of the seeds to be washed. The washing and moistening can also take place at higher or lower temperatures than the above stated temperatures, although at these higher or lower temperatures a less effective washing and moistening can generally be realized and/or a premature germination can take place. Problems can however occur at temperatures above 40° C., since not all types of seed can withstand such high temperatures. Pasteurization of the seeds will occur at temperatures between 45 and 55° C., whereby micro-organisms present on or in the seeds will generally be killed, which can be advantageous in determined situations.

In a preferred embodiment the seeds are moistened during step A) to a moisture content lying between 30 and 60% by mass of the seeds. The development of the seeds, and in particular the germinative process in the seeds, can be optimized by moistening the seeds until the seeds have reached such a moisture content. The most ideal moisture content of the seeds depends on the nature of the seeds, and will usually differ per type of seed. The period of time required to enable sufficient moistening of the seeds also depends on the type of seed, but will generally lie between 1 hour and 24 hours. In order to enable optimizing of the washing and moistening process of the seeds as according to step A), the seeds will preferably be kept moving during step A). In this way a homogenous and complete washing and moistening of the seed mass can take place, and this will enhance the final seed quality. Keeping the seeds moving during step A) does not necessarily have to take place continuously, but may also be discontinuous (interrupted). The direction of displacement and/or the speed of displacement of the seeds can also be modified during performing of step A).

Research has shown that 1 kg of seeds can absorb about 1 kg of liquid. It is therefore advantageous when the ratio between the weight of the seeds and the weight of the liquid brought into contact with the seeds during step A) lies between 1:3 and 1:20, preferably between 1:6 and 1:10, thereby ensuring an excess of liquid. It has been found that the ratios 1:6 and 1:10 are practical and efficient in being able to arrive at a satisfactory washing and moistening of the seeds. While a greater excess of liquid, such as for instance 1:50, could also result in a satisfactory washing process, the excess of liquid is so great in this case that such an excess is less efficient, and therefore usually undesirable.

The salt content in the aqueous liquid preferably lies between 0.05 and 0.5% by mass so as to keep the osmotic potential sufficiently low, so that the level of the ion content, in particular the potassium content, in the seeds can be maintained. The liquid with a salt content falling within the above stated range will moreover have a sufficiently high osmotic potential to enable moistening of the seeds and to be able to prevent dehydration of the seeds. Higher concentrations, such as for instance 10% by mass, can also be envisaged, although this is usually less favourable from an economic viewpoint. The liquid preferably comprises at least one potassium salt. Potassium salts generally dissolve readily in the aqueous liquid, wherein potassium is particularly important in the development and quality of the seeds. The ultimate germinative capacity of the seeds can be improved to a greater extent by allowing the seeds to absorb the potassium-containing liquid. In a particular preferred embodiment the liquid comprises K₃PO₄. The readily soluble salt K₃PO₄ is on the one hand potassium-rich and, because of the phosphate group that is present, provides on the other sufficient basicity to enable the pH of the liquid to be held between 9 and 13. No additional base or alkaline salt need therefore be added to the aqueous liquid to enable the pH to be held between 9 and 13. The pH of the liquid will however generally fall to some extent during performing of step A) as a result of acids being released from the seeds, such as for instance the phenol. However, by applying an excess of liquid this drop in pH can be kept relatively limited. In the case K₃PO₄ is applied, this salt then also acts as a buffer enabling the pH to be held more or less constantly in the alkaline range. It is also possible to envisage applying other salts or a combination of salts in order to enrich the liquid so as to make it alkaline and/or provide it with ions favourable for the seeds, whereby leakage of these ions out of the seeds can be prevented. In addition to potassium ions, it is known that ions of sodium, calcium, magnesium, chlorine and phosphates and sulphates can leak out of viable seeds. Examples of other salts which can be applied in the liquid are: K₂HPO₄, KOH, Na₃PO₄, Na₂HPO₄, (NH₄)₃PO₄, (NH₄)₂HPO₄, Na₂CO₃, NaHCO₃, K₂SO₄ and KHSO₄. Variants or other salts can also be applied, wherein it will generally be necessary to take into account that the forming of precipitation in the washing liquid will be prevented, or at least discouraged.

It has been found particularly advantageous to subject the seeds brought into contact with the liquid to ultrasonic vibrations at least temporarily during step A). These are generally vibrations having a frequency above 18,000 Hz. The process of washing the seeds can usually be made more effective by subjecting the seeds to ultrasonic vibrations, since phenols and similar (binding) components can be vibrated loose from the seeds, and this can generally improve the washing of the seeds considerably. The seeds can be subjected (permanently) to the ultrasonic vibrations during the whole washing process, although it is also possible to envisage this taking place temporarily or for instance in pulsating manner. Electromagnetic radiation of other frequencies can also be applied, although this will generally be less efficient than when ultrasonic waves are applied to irradiate the seeds.

In a preferred embodiment the seeds are dried during step B) to a moisture content of between 20 and 45% by mass of the seeds, wherein the optimum moisture content depends on the type of seed. The final moisture content of the seeds after drying is preferably lower here than the moisture content that the seeds will reach during an optional (and generally applied) subsequent priming process.

The drying can take place in active, forced manner or in passive, natural manner. When the seeds are dried in passive manner, the seeds will be conserved under atmospheric conditions, whereby the moisture content of the seeds will decrease gradually. The moisture content is however preferably reduced in more forced manner to enable the time duration of the drying process to be limited. The seeds are preferably dried here during step B) in a climate with a temperature between 20 and 40° C. Drying at higher temperatures is not usually desirable because damage can then occur in the seeds, and this will usually have an adverse effect on the germinative capacity of the seeds unless drying at higher temperatures takes place in particularly controlled manner, whereby a so-called heat shock is deliberately created in the seeds wherein advantageous proteins are produced in the seeds. Drying at temperatures lower than 20° C. is possible, although this is generally relatively slow and therefore less advantageous. It is also possible to envisage the seeds being dried during step B) in a climate with a relative (low) air humidity of between 20 and 45%, which also stimulates drying of the seeds. Drying at air humidities lower than 20%, such as for instance 15%, is generally undesirable since this results in excessive drying, wherein the water-requiring cell membranes of the seeds will usually be damaged. It may be advantageous to keep the seeds moving continuously or discontinuously during drying of the seeds in order to be able to effect a homogenous and relatively rapid drying of the seeds. Drying of the seeds can also be realized by bringing the seeds into contact with an absorbent substance, such as for instance silica gel. Such a drying process is however usually relatively slow.

In an alternative preferred embodiment the washing and drying cycle according to steps A) and B) is repeated at least once, which can improve the quality of the seeds to a further extent. After a first drying of the seeds as according to step B), the seeds will thus be washed and moistened again as according to step A), after which the seeds will again be dried as according to step B).

The method preferably also comprises step C), comprising of priming the seeds subsequent to the drying of the seeds as according to step B). In this way the seeds, and in particular the germinative capacity thereof, can be further developed in controlled manner without (substantial) germination occurring here. During priming the seeds are brought into contact with a substance, usually a liquid, with a relatively high osmotic potential, whereby controlled hydration of the seeds will occur. In a preferred embodiment priming of the seeds takes place during step C) by means of at least one of the following techniques: osmotic priming, hydro-priming and/or solid-matrix priming. These commercial techniques have been known for several decades. In osmotic priming the seeds are brought into contact with an osmotically active substance dissolved in water, such as for instance a salt or polyethylene glycol, so as to enable the absorption of water by the seeds to proceed in controlled manner. A certain washing effect is usually also realized by means of osmotic priming. This method is also usually referred to as “osmopriming”. In hydro-priming the seeds are brought into contact with water, in particular water vapour, a water film or an excess of water. A particular embodiment of hydro-priming is drum-priming, wherein the seeds are arranged in a perforated drum and there brought into contact with water vapour. In solid-matrix priming use is made of a water-absorbent carrier, such as for instance clay or carbon, which is then brought into contact with the seeds, after which imbibition of water by the seeds can take place. Irrespective of the technique applied for priming the seeds, the seeds will have to be planted as quickly as possible after applying the method according to the invention. In the case where the treated seeds are not planted, they will generally have a limited lifespan relative to untreated seeds unless the seeds are dried (dehydrated). Sufficient water absorption, the oxygen content and an optimal temperature range are generally of great importance for an optimal priming. Hormones, chemicals, such as for instance salts, can also be added to the seeds during priming. The seeds can optionally be additionally illuminated.

The invention also relates to a device for treating plant seeds by applying the method according to the invention, comprising: a moistening chamber for moistening the seeds with aqueous liquid comprising a salt, which liquid has a pH lying between 8 and 13, and a drying chamber for drying the seeds after moistening of the seeds. The moistening chamber and the drying chamber can herein be mutually integrated, wherein a perforated drum is preferably applied. The device optionally also comprises an activating chamber for priming the seeds. Priming of the seeds can herein also take place in the perforated drum, whereby the full method according to the invention can be performed in a single compartment, in particular a perforated drum. It will be apparent that it is also possible to envisage applying a different chamber for each treatment step (moistening, drying, activating), these chambers being connected to each other. Advantages and the operation of the device according to the invention have already been described at length in the foregoing.

The invention will be elucidated on the basis of the two following non-limitative exemplary embodiments, in which reference is made to the accompanying tables and figures. Herein:

table 1 shows an overview of germination percentages of fennel seeds over a period of time, wherein the fennel seeds have been treated in different ways,

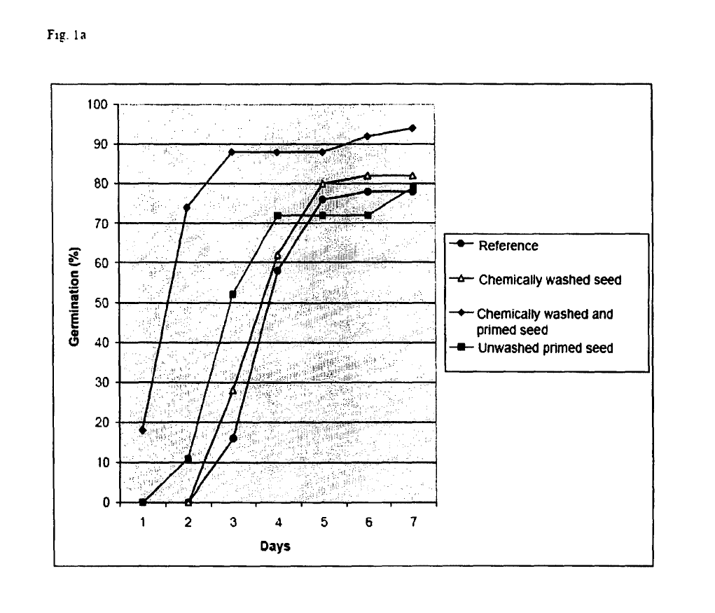

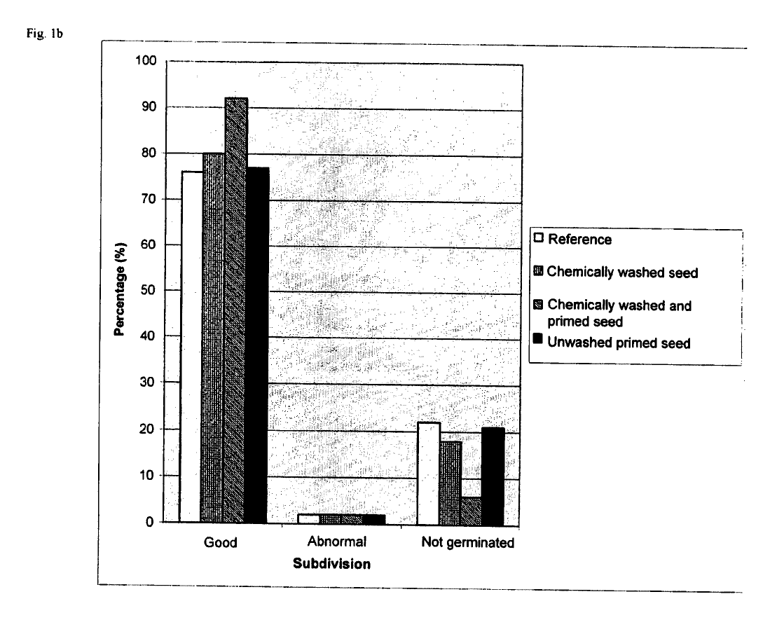

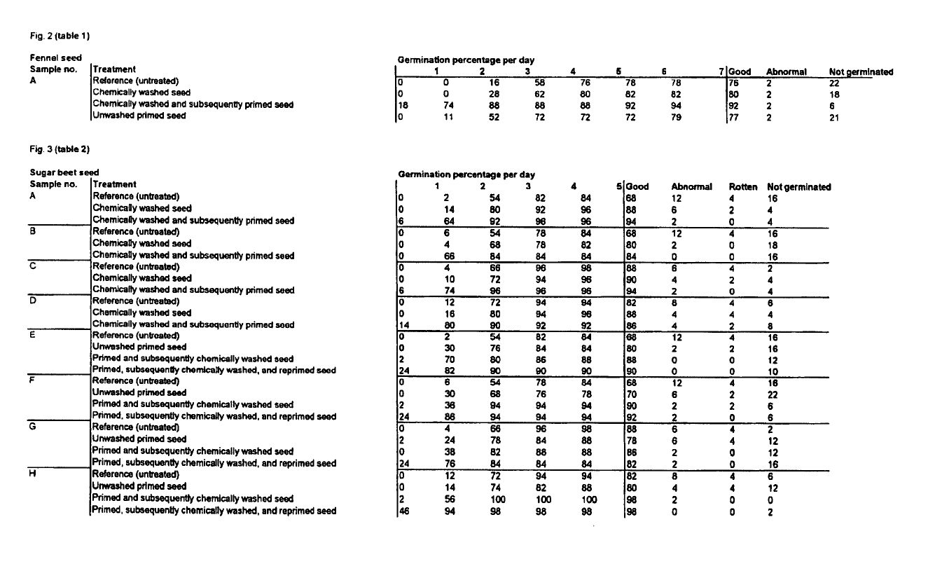

FIG. 1a is a graphic representation based on table 1 of germination percentages of fennel seeds over a period of time,

FIG. 1b is a graphic representation based on table 1 of the quality distribution of fennel seeds after a period of seven days, and

table 2 shows an overview of germination percentages of sugar beet seeds over a period of time, wherein different samples of the sugar beet seeds have been treated in different ways.

Table 1 shows an overview of germination percentages of fennel seeds over a period of time, wherein the fennel seeds have been treated in different ways. Table 1 shows that different fractions of the same fennel seed sample A had been treated in different ways, wherein one fraction has remained untreated.

Other fractions have been respectively chemically washed, chemically washed and subsequently primed, and directly primed (without washing). The chemical washing herein takes place in accordance with the method according to the invention. The germination percentage of the seeds over a period of time is shown in days. It can for instance be seen here that after two days 28% of the chemically washed seeds have germinated, while only 16% of the untreated seeds have germinated, whereby the advantageous effect of chemical washing is evident. A substantial improvement occurs in the case the seeds were primed following the chemical washing, whereby after two days 88% of the seeds had already germinated. The germination percentages of the different fractions as a function of time are also shown in FIG. 1a. The right-hand part of table 1 shows the quality distribution of the seeds germinated after seven days. It can be for instance seen here that, of the 94% of germinated seeds which have been both washed and primed, 92% were assessed as qualitatively good and 2% as qualitatively unsatisfactory. A percentage of 6% of this seed fraction has thus not germinated. This quality distribution is shown graphically in FIG. 1b. Clearly shown is that the chemical washing enhances the quality of the fennel seeds, and that a substantial improvement in quality can be seen in the case the fennel seeds are both washed and primed. Table 1 and FIG. 1b also show that the number of germinated seeds increases in the case the method according to the invention is applied.

Table 2 shows an overview of germination percentages of sugar beet seeds over a period of time, wherein different samples A-H of the sugar beet seeds have been treated in different ways. The interpretation of values from table 2 is made in similar manner as the interpretation of values from table 1. Shown clearly once again is that the chemical washing according to the invention has a positive effect on the germination behaviour of the seeds, and in particular on the number of germinating seeds and the quality of the germinating seeds. Particular improvements occur in the case the washed seed is subsequently primed (see samples A-D). In the case the sequence of washing and priming is reversed, wherein the seeds are first primed before being washed (see samples E-H), considerable improvements in the germination behaviour can also be observed. Priming, washing and priming again is also favourable in respect of the number of germinating seeds as well as the seed quality (see samples E-H).

It will be apparent that the invention is not limited to the exemplary embodiments shown and described here, but that numerous variants which will be self-evident to the skilled person in this field are possible within the scope of the appended claims.

1. Method for removing germination inhibitors from plant seeds comprising the steps of:
A) moistening plant seeds for a period of time with aqueous liquid comprising a salt, which liquid has a pH lying between 7.5 and 14, and
B) drying for a period of time the seeds moistened during step A).

2. Method as claimed in claim 1, wherein the temperature of the liquid lies between 3 and 10° C.

3. Method as claimed in claim 1, wherein the seeds are moistened during step A) to a moisture content lying between 30 and 60% by mass of the seeds.

4. Method as claimed in claim 1, wherein the seeds are kept moving during step A).

5. Method as claimed in claim 1, wherein the ratio between the weight of the seeds and the weight of the liquid brought into contact with the seeds during step A) lies between 1:3 and 1:50.

6. Method as claimed in claim 1, wherein the period of time in which the seeds are brought into contact with the liquid during step A) lies between 1 and 24 hours.

7. Method as claimed in claim 1, wherein the salt content in the aqueous liquid lies between 0.05 and 0.5% by mass.

8. Method as claimed in claim 1, wherein the liquid comprises at least one potassium salt.

9. Method as claimed in claim 8, wherein the liquid comprises K₃PO₄.

10. Method as claimed in claim 1, wherein the seeds brought into contact with the liquid are subjected to ultrasonic vibrations at least temporarily during step A).

11. Method as claimed in claim 1, wherein the seeds are dried during step B) to a moisture content of between 20 and 45% by mass of the seeds.

12. Method as claimed in claim 1, wherein the seeds are dried during step B) in a climate with a temperature between 20 and 40° C.

13. Method as claimed in claim 1, wherein the seeds are dried during step B) in a climate with a relative air humidity of between 15 and 45%.

14. Method as claimed in claim 1, wherein the seeds are kept moving during step B).

15. Method as claimed in claim 1, wherein after performing step A) and step B), step A) and step B) are performed at least once again.

16. Method as claimed in claim 1, wherein the method also comprises step C), comprising of priming the seeds subsequent to the drying of the seeds as according to step B).

17. Method as claimed in claim 16, wherein priming of the seeds takes place during step C) by means of at least one of the following techniques: osmotic priming, hydro-priming and/or solid-matrix priming.

18. Device for removing germination inhibitors from plant seeds by applying the method as claimed in claim 1, comprising:
a moistening chamber for moistening the seeds with aqueous liquid comprising a salt, which liquid has a pH lying between 7.5 and 14, and
a drying chamber for drying the seeds after moistening of the seeds.

19. Device as claimed in claim 18, wherein the moistening chamber and the drying chamber are mutually integrated.

20. Device as claimed in claim 18, wherein the moistening chamber and/or the drying chamber are formed by a perforated drum.

21. Device as claimed in claim 18, wherein the device also comprises an activating chamber for priming the seeds.
